(19) United States
(12) Patent Application Publication
(10) Pub. No.: US 2014/0354974 A1
(43) Pub. Date: Dec. 4, 2014

(54) Apparatus and Method for Monitoring the Mechanical Properties of Subsea Longitudinal Vertical Components in Offshore Drilling and Production Applications

(71) Applicant: David V. Brower, Houston, TX (US)

(72) Inventor: David V. Brower, Houston, TX (US)

(21) Appl. No.: 13/909,344

(22) Filed: Jun. 4, 2013

(51) Int. Cl. G01L 1/24

(52) U.S. Cl. CPC G01L 1/242
USPC 356/32

(57) ABSTRACT

An apparatus to monitor the loads and mechanical behavior of subsea longitudinal vertical components of off shore drilling and production platforms (SLVCs) uses sensors attached directly to the tendons by adhesive or by friction mount. The sensors are typically in a sensor ring assembly which is placed around the perimeter of the SLVC. Ruggedized cables carry the sensor reading from the ring assembly to the SLVC working platform and to a control center for monitoring the action and stresses on the tension legs. The system may be deployed on existing SLVCs or may be installed on new construction during initial assembly and installation.

### BACKGROUND OF THE INVENTION

1. Field of the Invention

The subject invention is generally related to measuring systems for monitoring the effect of environmental elements on subsea components in offshore oil and gas drilling and production and is specifically directed to fiber optic sensing systems employed as monitoring and measurement apparatus.

2. Discussion of the Prior Art

Offshore drilling and production systems include a surface working platform in communication with a production field beneath the seafloor. All such systems have one feature in common, which is that a conduit of some sort is required to support drilling equipment and materials being delivered from the surface work platform to the subsea field, and/or a conduit for lifting oil and gas being produced from the subsea field to the surface work platform. In typical cases the conduit is a tubular pipe extending from the subsea field to the surface, generally referred to as a riser.

One such example of an offshore drilling and production system is a tension leg platform (TLP) which is a permanently positioned structure used for the production of oil and gas in offshore environments using tension legs to support the platform above the sea surface. Other examples may be floating rigs, jack-up rigs and myriad other systems. In many of these systems, in addition to the aforementioned operating conduits, some sort of legs or equivalent support structure is extending from the sea floor to a working platform above the surface of the sea.

It is important to provide data relating to the reaction of the conduits and support structures to the movement of the seawater and to other changes in condition such as temperature, pressure inside the conduit, and the like.

In TLP systems, for example, buoyancy is provided in the tension legs by controlling the pressure in the legs. Buoyancy is typically provided by four large air filled canisters upon which the topside structure resides. TLPs are constructed by using tendons that are vertically attached to the platform corners and anchored to pilings that have been driven into the sea floor. This design feature restricts vertical motion of the platform that would otherwise occur due to tides and wave action. Some recent TLP designs alter the way buoyancy is provided but the basic tendon feature remains. A major advantage results for TLP structures is that the wellhead can be placed on the surface rather than on the sea floor giving better access and simpler production control. TLPs are typically used in water depths ranging from 1000 to 5000 feet. Recently, TLPs have been proposed for use as a base for offshore wind turbines, as well.

The tendons are an important TLP component. These tendons are made of tubular steel and are highly tensioned. In order for the TLP system to work properly the tendons must be kept under tension. In order to ensure safe and economic operation of TLPs a tendon tension monitoring system is required to provide reliable measurement of the tension in each of the tendons. A record of these loads along with displays of all the data are available in real-time and in various formats.

In a typical installation three load sensors are installed into the tendon top connector assembly, which is on a sub-platform or bridge for each tendon, below the primary work platform. The data from these sensors is then used to calculate the maximum, minimum and mean tensions and standard deviation in the tendon, together with the bending movement angle. A typical prior art load cell element comprises a marine grade stainless steel base with mechanical strain gauges installed onto the base as independent strain gauge bridge networks, a primary and secondary, and then a stainless steel cover is welded over the billet to provide hermetic sealing and protection for the strain gauges. The wires from each bridge are brought through glass-to-metal seals to separate underwater connectors. The load cell is then coated with a marine grade finish and supplied with a top cover to allow for any misalignment within the tendon connector rings.

Specifically, these prior art load sensor systems typically consist of load cells that are attached to the tendon top and a large metal structure attached to the hull. The load cells are located sub-surface. The strain gauges are mechanical gauges. Historically, the load cells are unreliable and often fail early in their service life.

The operation of the TLP requires applied tension and a reliable monitoring system is crucial. When the monitoring system fails it is often necessary to shutdown the platform at great expense and loss of production time.

The risers for all offshore platforms, as well as the aforementioned tension legs for TLPs, are subject to environmental conditions, particularly the flow, wave action and temperature of the seawater. These conditions effect the tension, bending, compressive forces, temperature expansion and contraction, internal pressure, and other strains and stresses to which the conduit, leg and or riser are subjected.

Various devices and systems have been deployed to measure the effect of these conditions, such as, by way of example, the load cells on TLPs, mechanical strain gauges, invasive sensors which penetrate the conduit, and other similar systems. All of these are of limited functional value and are subject to early fatigue caused by the rigorous conditions in which they are employed.

Similar monitoring and measuring systems are also useful for other system components such as, by way of example, risers. All of these components, including both tension legs for TLPs and risers, as well as other generally vertical components extending from the seafloor to the surface, may be referred to as subsea longitudinal vertical components or SLVCs. Most monitoring and measuring systems employed on SLVCs have to be installed during initial construction, and cause major shutdown periods and expense when they fail.

### SUMMARY OF THE INVENTION

In the broadest sense, the subject invention is an apparatus for measuring the mechanical properties of an SLVC, comprising a sensor ring assembly mounted substantially about the outer perimeter of the SLVC at a desired location the sea surface. One or more fiberoptic sensors are mounted in the ring and in communication with the SLVC, the sensors adapted for collecting at least one of the following data relating to the stress, strain, compression, expansion, twisting of the SLVC as it responds to subsea environmental conditions. Where desired, temperature data may also be collected. A ruggedized umbilical cable is attached to the sensors for communicating sensor data to the surface. The sensor ring is adapted to be placed around a perimeter of the SVLC and is secured to the SVLC using subsea adhesive, friction mount, or a combination. The fiberoptic sensors include sensor elements mounted in the ring and in communication SVLC.

The subject invention provides a new method and apparatus for monitoring the stress, strains, twisting, tension, compression, temperature and motion of conduits and other subsea longitudinal vertical components (SLVCs) that extend for the sea floor to a surface platform for measuring, analyzing and displaying the mechanical property data for SLVCs in a reliable manner using fiber optic sensors rather than the typical mechanical strain gauges of the prior art. This provides a more reliable and more robust system than the monitoring equipment of the prior art. In addition, the system of the subject invention is less costly than prior art load cells, for example. When incorporated in the original design of new SLVCs the system of the subject invention provides significant cost savings due to the reduction of material previously necessary to accommodate load cell support structure. This is true of other applications as well.

Another major advantage is that the apparatus can be installed either before or during initial installation or after the platform is placed in service. This is particularly useful since the many offshore systems now in use can be retrofitted with the system of the subject invention. Such retrofits can be accomplished in a fraction of the time required to replace or repair prior art systems, if such systems can be replaced at all

Not only can sensors from the invention measure load, but they can measure bending, torsion, wave and ocean swell action, temperature, and vibration, greatly expanding the data available for analysis in determining the viability of the platform.

Specifically, the subject invention provides novel apparatus and method for monitoring the structural loads on SLVCs. The components of the system are attached directly to the tendon leg instead of a base component which, in turn, is mounted on the tendon. The sensing components incorporated in the system eliminate the requirement for load cells.

The system can be applied to existing tendons that are in service as well as in new construction. The components are rugged, reliable and low cost compared to prior art systems. In addition, the system of the invention reduces the support structure required with a typical integrated load cell systems.

In the preferred embodiment of the system fiber optic sensors provide the measuring component. The most common embodiment incorporates Fiber Brag Gratings. However, other fiber optic sensing methods such as, by way of example, Sagano, Micheloson, or Fabry Perot configurations and the like, may be used as a matter of choice.

In the alternative, electric sensors in combination with restive strain gauges, accelerometers or potentiometers may also be used where desired without departing from the scope and spirit of the invention.

In the preferred embodiment, a polymer, composite or metal housing encapsulates the sensing elements and provides a barrier to moisture intrusion and protection from damage. Polyurethane is the preferred housing material. A ruggedized cable is used to connect the sensors to the topside control room. The cable is typically configured as an integral part of the polymer housing. A temperature compensation sensor is installed in the apparatus to correct for any temperature effects on the strain measurement. The temperature compensation sensor is located in close proximity to the strain sensors but is isolated from the strain field. The addition of polymer to the sensor station provides a protective layer from damage, provides a moisture barrier, and helps as a medium to hold the system together during handling and installation. Cabling and connection wiring are embedded in the polymer housing and carry the sensor signals. A cable egress point may have a stress relief component to ensure cable damage potential is minimized.

The system is mounted on the tendon using subsea adhesive. In an alternative embodiment a clamp having a friction surface that partially penetrates the surface of the tension may be used as a mounting system. Where desired, a combination of friction and adhesive mounting systems may be used. A novel ruggedized cable protects the system during handling and deployment. The ruggedized cable is a conductive core with a shield of ruggedized material such as a polymer, Kevlar, Polyarmide, carbon fiber, graphite and the like. A typical ruggedized cable is shown and described in my copending application SN.

### BRIEF DESCRIPTION OF THE DRAWINGS

FIG. 1 is an overview of a TLP with the sensor system of the subject invention mounted on the tension leg SLVCs.

FIG. 2 is a perspective view of a tendon leg platform sensor assembly for adhesive mount to the tendon.

FIG. 3 is a partial view similar to FIG. 1, with the polyurethane body removed and showing placement of the sensors mounted thereon.

FIG. 4 is a perspective view of the sensor assembly with the polyurethane body removed, as in FIG. 3, and shows the interior wall of the body and clamp.

FIG. 5 shows the locking mechanism for locking the assembly to the SLVC tension leg.

FIG. 6 illustrates the sensor station cable routing and attachment for the assembly.

FIG. 7 is a perspective view of utilized for friction mount of the sensor assembly to the tendon.

FIG. 8 is a perspective view of the friction plates and sensors used in connection with the clamp of FIG. 7.

### DESCRIPTION OF THE PREFERRED EMBODIMENT

While the invention as described is illustrated using the sensor system 14 on the tension legs of a typical TLP 10, it should be understood that the system is readily adaptable to any SLVC incorporated in offshore drilling and production. The system is particularly useful, and similarly installed on risers, tension legs and other SLVC used during both the drilling and the production phase of the platform.

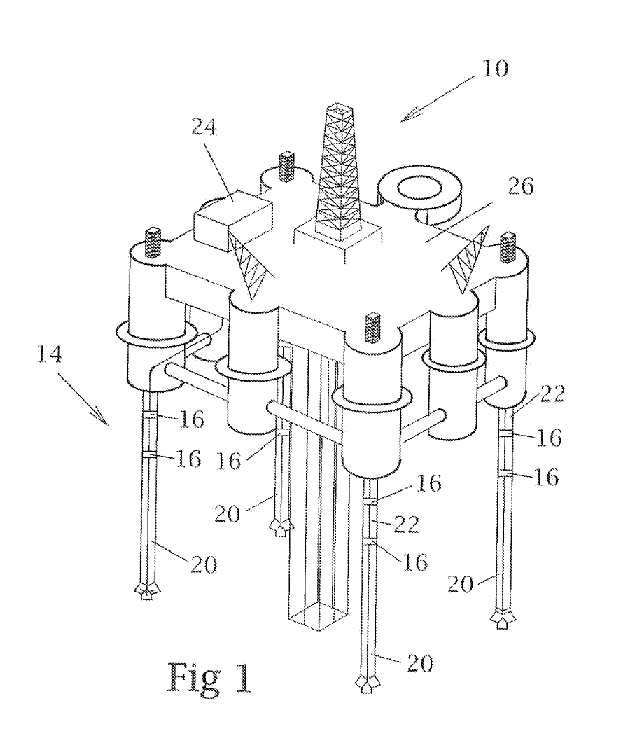

A TLP 10 with the sensor system 14 is shown in FIG. 1. In the preferred embodiment, the sensor system includes two groups of sensor assemblies 16 mounted on each tension leg 20. In the example, a first sensor ring 18 is mounted approximately thirty feet (eight to ten meters) from the mean sea surface and a second sensor ring 20 is mounted approximately sixty feet (sixteen to twenty meters from the surface. In some applications, it may be desirable to provide sensors strategically placed at intervals extending from the seafloor to a location near the surface platform. An umbilical of ruggedized cable 22 connects the sensor rings to the a control center 24 on the main platform 26 of the SLVC.

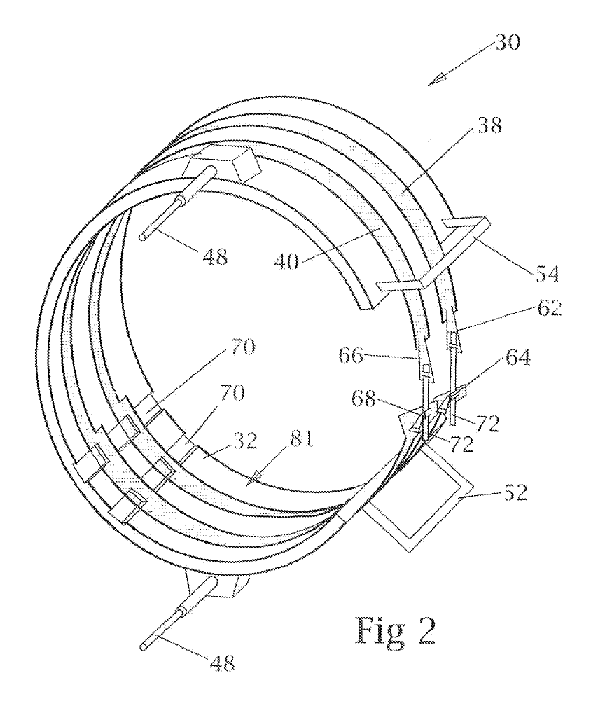

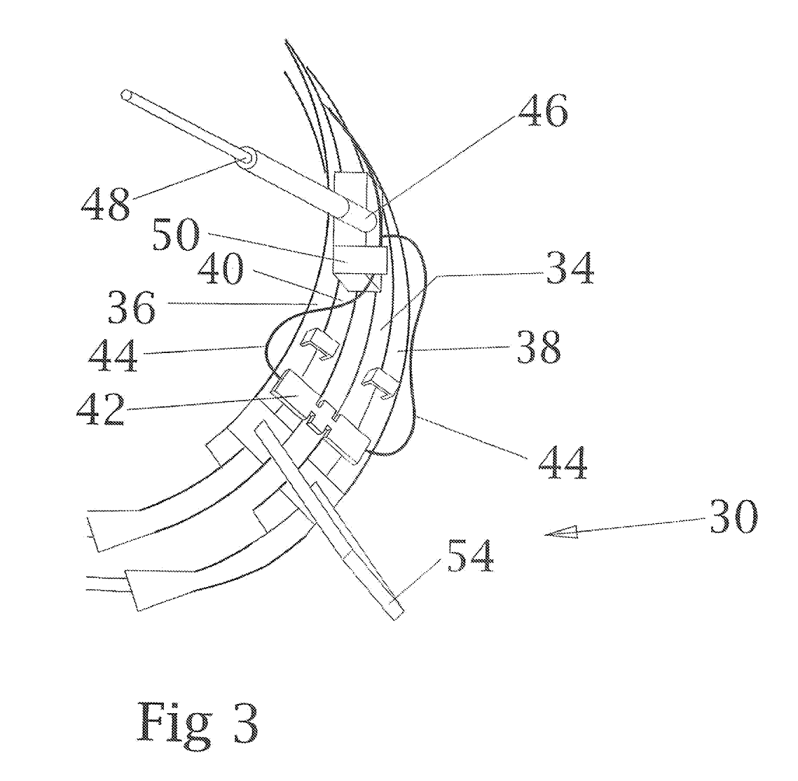

The sensor ring assemblies 30 are shown in FIGS. 2-8. The assembled adhesive ring is shown in FIG. 2 As best seen in FIG. 3, with the polyurethane shield 32 removed, the assembly comprises a pair of inner parallel straps 34, 36 for supporting the sensors, and a pair of outer parallel straps 38, 40 for providing strength to the assembly. The straps are axially spaced apart to accommodate one or more sensors 42 which are spot welded to the inner parallel straps 32, 34.

Cables 44 extend from each sensor 44 in the space between the inner and outer straps and to a coupler 46 for communicating the sensor readings to a ruggedized umbilical 48. Typically, a tube clamp 50 is utilized to stabilize the tube and cable 50 when the polyurethane cover is in place.

A pair of handles 52, 54 are mounted on the outer rings 38, 40 for facilitating handling of the assembly. The ring assembly is then covered with a polyurethane blanket 60, as shown in FIG. 2, with only the exiting cables or umbilicals 48, the handles 52, 54, and the outer ends 62, 64 of strap 38 and the outer ends 66, 68 of strap 40 being exposed.

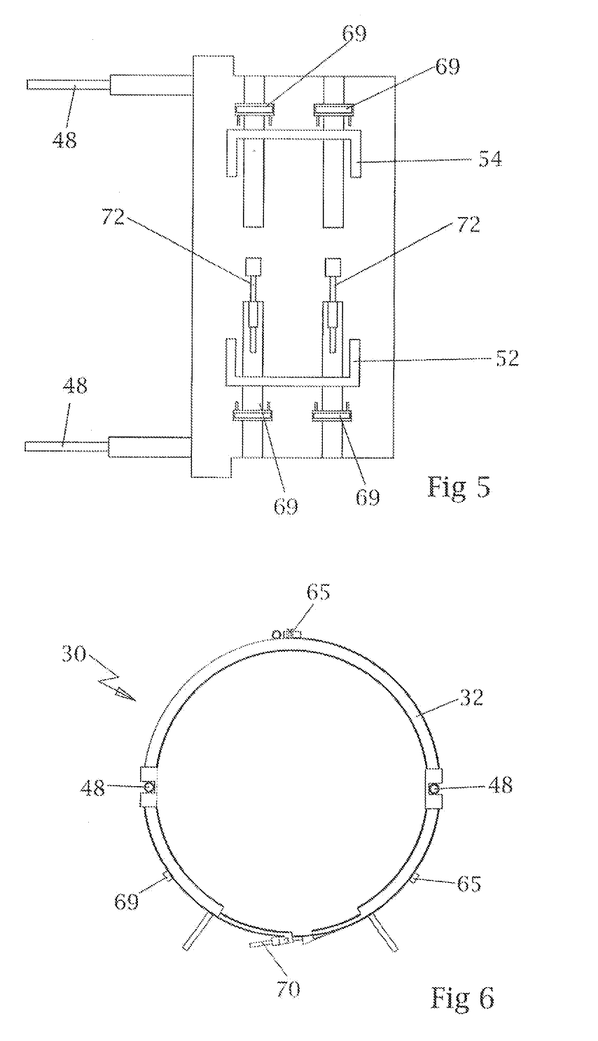

It may be desirable to provide grooves 70 in the polyurethane blanket to facilitate flexibility of the clamp ring when it is being installed on a tendon leg. The straps 38 and 40, as well as the inner straps 34 and 36 are sufficiently flexible to permit the ring to be opened, permitting it to be placed circumferentially about the tendon leg, as shown in FIG. 1. Locking bolts or other locking means 72 may then be utilized to tighten the ring assembly to the tension leg, see FIG. 5. In the configuration of FIGS. 1-5, the inner surface of the polyurethane blanket is coated with a subsea adhesive for permanently mounting the sensor rings to the tendon leg.

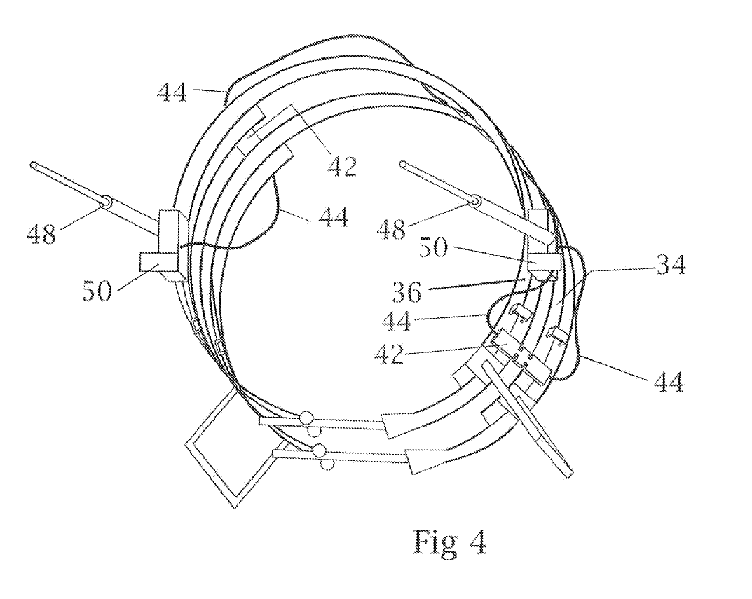

As is best shown in FIG. 4, the sensors 42 are placed strategically around the inner rings 34, 36 to provide accurate and redundant readings. The sensor cables 44 are then embedded in the polyurethane blanket and are coupled to the ruggedized umbilical 48 at the tube clamps 50. The sensors mounted in the way detect minute movements of the tendon leg as the parallel bands move with the expanding, contracting, bending and vibrating tendon leg. Not only can sensors from the invention measure load, but they can measure bending, torsion, wave and ocean swell action, temperature, and vibration. A temperature compensation sensor is installed in the apparatus to correct for any temperature effects on the strain measurement. The temperature compensation sensor is located in close proximity to the strain sensors but is isolated from the strain field. The addition of polymer blanket to the sensor station provides a protective layer from damage, provides a moisture barrier, and helps as a medium to hold the system together during handling and installation. The cabling and connection wiring are embedded in the polymer housing and carry the sensor signals. The cable egress point may have the stress relief component such as the tube clamp shown, to ensure cable damage potential is minimized.

The umbilical carries the sensor signals to the surface along the tendon leg, see FIG. 1 and to the main working platform 26 of the SLVC. This is a departure from the prior art, where the load cells were generally on the bridge platforms beneath the working platform. A control station or control shed 24 (FIG. 1).

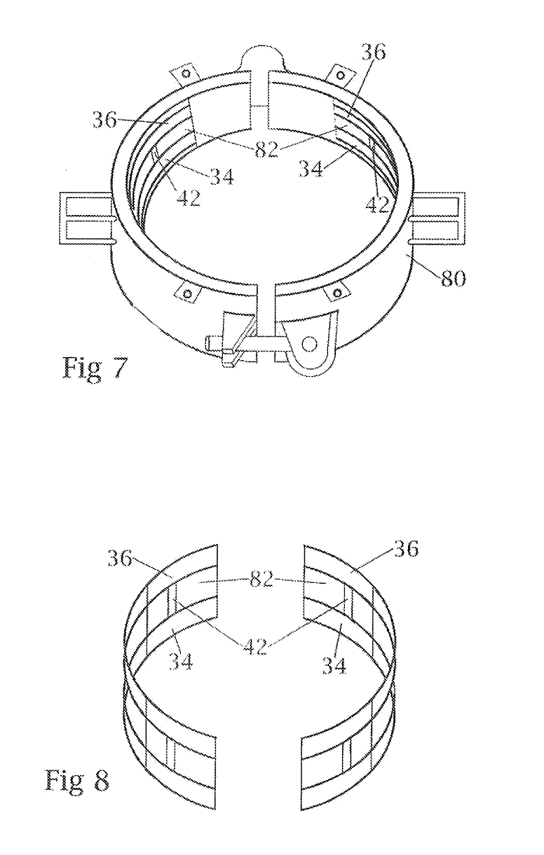

An alternative mounting system is shown if FIGS. 7 and 8. The ring assembly is substantially the same as in the adhesive embodiment with the polyurethane blanket having an OFI (full name) 80 clamp on the outer periphery and a series of friction plates 82 mounted on the interior. The friction plates are designed to grab and slightly penetrate the tendon leg to assure a good bond. The friction system may be used in combination with the subsea adhesive, where desired.

A significant advantage of the invention is that the sensor assemblies can be applied to existing tendon legs that are already inn service. The devices are rugged, reliable and are low cost compared to prior art systems. The system can also be utilized on new construction, permitting additional cost savings by eliminating the bridge platforms for the load cells.

The preferred embodiment of the invention incorporates Fiber Bragg Gratings, but other fiber optic sensing methods are also acceptable, such as, by way of example, distributed strain, Sagano, Micheloson, or Fabry Pero configurations. Electrical based sensors are an option for the measuring means with restive strain gauges, accelerometers, or potentiometers.

In new construction, the sensor ring assemblies may be mounted on the tendon legs before the platform is assembled. The umbilicals may then be attached to the control station once the SLVC is in place. In a retrofit system, divers or undersea robots are used to deliver the sensor rings to the desired location on the SLVC and mounted on the SLVC without requiring any disassembly of the platform system or the SLVC.

While certain features and embodiments of the invention have been shown in detail herein, it should be understood that the invention encompasses all modifications and enhancements within the scope and spirit of the following claims.

What is claimed is:

1. An apparatus for measuring the mechanical properties of an SLVC, comprising:
a. A sensor ring assembly mounted substantially about the outer perimeter of the SLVC at a desired location the sea surface;
b. A fiberoptic sensor mounted in the ring and in communication with the SLVC, said sensors adapted for collecting at least one of the following data relating to the stress, strain, compression, expansion, twisting of the SLVC as it responds to subsea environmental conditions; and
c. An umbilical cable attached to the sensors for communicating sensor data to the surface.

2. The apparatus of claim 1, the fiberoptic sensor adapted for collecting the temperature of the SLBC.

3. The apparatus of claim 1, wherein the sensor ring assembly further comprises:
a. A ring which is adapted to be placed around a perimeter of the SVLC;
b. Means for securing the ring to the SVLC in a manner rigidly coupling the fiberoptic sensor to the SVLC;
c. Wherein the fiberoptic sensor includes sensor elements mounted in the ring and in communication SVLC; and
d. Wherein the umbilical cable is ruggedized and extends along the outer periphery of the tension leg from the sensor ring to the surface.

4. The apparatus of claim 3 further comprising a cover enveloping the sensors for protecting them from the environment.

5. The apparatus of claim 4, wherein the cover is a polymer blanket.

6. The apparatus of claim 5, wherein the polymer blanket is a unitary blanket which is molded over the ring and sensor assembly for sealing the sensor assembly from the environmental elements.

7. The apparatus of claim 5, wherein the cover is made of polyurethane and is applied after the ring and sensor elements are assembled.

8. The apparatus of claim 1, wherein the SLVC is a tension leg for a TLP platform.
